(19) United States
(12) Patent Application Publication
(10) Pub. No.: US 2024/0233765 A1
(43) Pub. Date: Jul. 11, 2024

(54) METHOD FOR PRODUCING OPTICAL ELEMENT

(71) Applicant: Mitsubishi Chemical Corporation, Tokyo (JP)

(72) Inventors: Yuta OTSU, Tokyo (JP); Ken SATO, Tokyo (JP); Kazuma INOUE, Tokyo (JP)

(73) Assignee: Mitsubishi Chemical Corporation, Tokyo (JP)

(21) Appl. No.: 18/611,007

(22) Filed: Mar. 20, 2024

Related U.S. Application Data
(63) Continuation of application No. PCT/JP2022/040127, filed on Oct. 27, 2022.

(30) Foreign Application Priority Data
Oct. 28, 2021 (JP) 2021-176018
Dec. 29, 2021 (JP) 2021-215449

(51) Int. Cl. G11B 7/245; G03H 1/02; G11B 7/0065

(52) U.S. Cl. CPC G11B 7/245; G03H 1/0248; G11B 7/0065; G03H 2001/0264; G03H 2260/12

(57) ABSTRACT

A method for producing an optical element, comprising; performing recording exposure on a medium having a recording layer containing a polymerizable compound and a photopolymerization initiator; and further performing post exposure on the medium in a state where the temperature of the medium is lower than during the recording exposure. A method for producing an optical element, wherein the recording exposure is holographic recording exposure.

### TECHNICAL FIELD

The present invention relates to a method of producing an optical element on which a hologram or the like is recorded.

### BACKGROUND ART

A holographic recording medium, which has been attracting attention in recent years, is a recording medium that utilizes light interference and diffraction phenomena. A hologram is a recording method in which an interference pattern created by interference fringes of two lights called a reference light and an object light (also referred to as information light or signal light) is three-dimensionally recorded inside a recording medium. A holographic recording medium contains a photosensitive material in its recording layer. In a holographic recording medium, interference fringes are recorded by chemically changing the photosensitive material in accordance with the interference pattern and locally changing its optical properties.

A holographic recording medium has been developed for memory applications. As another use of the holographic recording medium, studies are being conducted to apply it to optical element such as light guide plate for AR glass (wave guide plate). In the case of AR glass (AR glasses) applications, the holographic recorded optical element used in the light guide plate is required to have a wide viewing angle, high diffraction efficiency for light in the visible region, and high transparency of the medium.

A holographic recording medium can be divided into several types depending on what kind of optical properties are changed. It has been considered that a volume type hologram medium, which performs recording by creating a refractive index difference within a recording layer having a thickness above a certain level, is advantageous for applications to a light guide plate of AR glass, because it can save space and achieve high diffraction efficiency and wavelength selectivity.

An example of a volume type holographic recording medium is a write-once type which does not require wet processing or bleaching. A composition of a recording layer thereof is generally one in which a photoactive compound is compatibilized in a matrix resin. For example, it is known to use a photopolymer, as a recording layer, in which a matrix resin is combined with a polymerizable reactive compound, as a photoactive compound, capable of radical polymerization or cationic polymerization with a photopolymerization initiator (Patent Literatures 1-4).

When recording holograms, if there is a recording layer made of photopolymer in an area where interference fringes are formed by intersection of reference light and object light, a photopolymerization initiator causes a chemical reaction and becomes an active substance in the area of high light intensity among the interference fringes. This then acts on the polymerizable compound, causing it to polymerize. In this process, if there is a difference in refractive index between a matrix resin and a polymer generated from the polymerizable compound, the interference fringes are fixed in the recording layer as a difference in refractive index. In addition, when the polymerizable compound polymerizes, diffusion of the polymerizable compound occurs from the periphery, causing a concentration distribution of the polymerizable compound or its polymerized product inside the recording layer. Based on this principle, an interference pattern is recorded on the holographic recording medium as a refractive index difference.

Furthermore, by changing the intersection angle of this reference light and object light, different data can be recorded duplicately at the same position.

Hereinafter, the process of changing the optical characteristics of the recording layer by exposing the recording layer of the medium under predetermined conditions as described above will be referred to as “recording exposure.”

On the other hand, when reproducing data, only a reproduction light is used, and the irradiated reproduction light causes diffraction according to the interference fringes. At this time, even if the wavelength of the reproduction light does not match the wavelength of the recording light, diffraction will occur if the interference fringes and the Bragg condition are satisfied. Therefore, if corresponding interference fringes are recorded according to the wavelength and incidence angle of the reproduction light to be diffracted, it is possible to cause the reproduction light in a wide wavelength range to be diffracted. This allows the display color gamut of the AR glass to be expanded.

After recording exposure, it is common to perform post exposure in which the entire recording layer is irradiated with light. That is, when a hologram is recorded on a medium by recording exposure, post exposure is performed by irradiating light to areas other than the holographic recording area (hereinafter also referred to as “non-recording area”) (Patent Literatures 5 to 7). In this case, the post exposure is intended to fix the concentration distribution of the polymer formed by the recording exposure by accelerating the polymerization of the photopolymer in the non-recording area where the hologram is not recorded. Post-exposure is performed to prevent the polymerization reaction of the photopolymer by light after this process, so that the concentration distribution of the polymer formed by the recording exposure is not destroyed and new concentration distributions are not formed.

One issue with optical elements recorded with holograms in this way is that the optical elements themselves appear cloudy, although only slightly. The cloudiness is mainly caused by light scattering originating from the material that constituted the recording layer, and is called Haze. In particular, the optical performance required for AR glass light guide plate applications is severe. Therefore, in applications for AR glass light guide plates, even a slight Haze in the recording layer area other than the holographic recording area, that is, in the non-recording area, causes deterioration in image quality.

### PRIOR ART DOCUMENTS

### Patent Literature

[Patent Literature 1] JP 2021-12249 A
[Patent Literature 2] JP 2007-34334 A
[Patent Literature 3] JP H8-160842 A
[Patent Literature 4] JP 2003-156992 A
[Patent Literature 5] JP H10-187013 A
[Patent Literature 6] JP 2014-209217 A
[Patent Literature 7] JP 2005-134762 A

### SUMMARY OF INVENTION

### Technical Problem

An object of the present invention is to reduce Haze in a non-recorded area of an optical element on which a hologram or the like is recorded.

### Solution to Problem

The present inventors have discovered that by performing post exposure under specific conditions, it is possible to reduce Haze in the non-recorded area of an optical element on which a hologram or the like is recorded.

The gist of the present invention is as follows.

(1) A method for producing an optical element, comprising; performing recording exposure on a medium having a recording layer containing a polymerizable compound and a photopolymerization initiator; and further performing post exposure on the medium in a state where the temperature of the medium is lower than during the recording exposure.

(2) The method for producing an optical element according to (1), wherein the difference between the temperature of the medium during the recording exposure and the temperature of the medium during the post exposure is 5° C. or higher.

(3) The method for producing an optical element according to (1) or (2), wherein the temperature of the medium during the post exposure is 5° C. or higher.

(4) The method for producing an optical element according to any one of (1) to (3), wherein the temperature of the medium during the recording exposure is 10° C. or higher and 40° C. or lower.

(5) The method for producing an optical element according to any one of (1) to (4) wherein the post exposure is performed at a light intensity 0.3 times or more higher than that of the recording exposure.

(6) The method for producing an optical element according to any one of (1) to (5), wherein a light source for post exposure during the post exposure is incoherent light.

(7) The method for producing an optical element according to any one of (1) to (6), wherein the post exposure is performed from both sides of the medium.

(8) The method for producing an optical element according to any one of (1) to (7), wherein the recording exposure is holographic recording exposure.

### Advantageous Effects of Invention

According to the method for producing an optical element according to the present invention, it is possible to reduce Haze in a non-recorded area of an optical element on which a hologram or the like is recorded.

### BRIEF DESCRIPTION OF DRAWING

FIG. 1 is a schematic diagram showing an example of a holographic recording device on a medium.

FIG. 2 is a schematic diagram showing an example of a post exposure device for a holographic recorded medium.

FIG. 3 is a schematic diagram showing another example of a post exposure device for a holographic recorded medium.

### DESCRIPTION OF EMBODIMENTS

Hereinafter, embodiments of the method for producing an optical element of the present invention will be described in detail. The following description is an example (representative example) of an embodiment of the present invention. The present invention is not limited to these contents unless it goes beyond the gist thereof.

### [Method for Producing Optical Element of the Present Invention]

For example, when producing a holographic recorded optical element according to the present invention, first, a reference light and an object light (information light) are applied to a medium having a recording layer containing a polymerizable compound and a photopolymerization initiator. The reference light and the object light (information light) are crossed to form interference fringes, and the recording layer is exposed to record the interference pattern. Furthermore, post exposure is performed on this recording exposed medium.

In the present invention, the reference light is the light t serves as a reference when recording an interference pattern on a medium (hereinafter referred to as “recording exposure”), and is irradiated to this recording layer by overlapping an object light when exposing the recording layer of the medium.

The object light in the present invention is the light irradiated to the recording layer of the medium in order to record holograms in the medium with interference fringes corresponding to the interference with the reference light according to the wavelength and diffraction of the reproduction light required as an optical element used for AR glasses and the like.

The exposure amount in the present invention means the total amount of exposure energy per unit area of light irradiated to the medium having the recording layer.

The light intensity means the intensity (energy) per unit area of light irradiated to the medium having the recording layer.

### [Temperature During Recording Exposure and Post Exposure]

The ambient temperature during the above recording exposure is preferably 10° C. or higher, more preferably 15° C. or higher, and even more preferably 20° ° C. or higher, from the viewpoint of preventing light scattering by water droplets generated by condensation on the medium. Within this range, it tends to prevent the increase in Haze of the optical element due to water droplets generated by condensation on the medium. On the other hand, the ambient temperature during the above recording exposure is preferably 40° C. or lower, more preferably 35° C. or lower, and even more preferably 30° C. or lower. Within this range, it becomes easy to suppress deactivation of the photopolymerization initiator in the holographic recording medium due to high temperature, and it tends to be possible to maintain high diffraction efficiency.

The temperature of the medium during the recording exposure described above is preferably 10° C. or higher, more preferably 15° C. or higher, and even more preferably 20° C. or higher. By setting the temperature of the medium at 10° C. or higher, light scattering by water droplets generated by condensation on the medium during recording exposure tends to be prevented. Moreover, Haze of the optical element caused by this light scattering can also be prevented. The temperature of the medium during the recording exposure described above is preferably 40° C. or lower, more preferably 35° C. or lower, and even more preferably 30° C. or lower. By setting the temperature of the medium at 40° C. or lower, deactivation of the photopolymerization initiator in the holographic recording medium due to high temperature can be suppressed. Therefore, high diffraction efficiency tends to be maintained.

Furthermore, it is preferable that the temperature of the medium during the recording exposure described above is kept constant in order to prevent uneven interference fringes formed by the recording exposure maintain high diffraction efficiency by keeping the density and refractive index of the medium constant. Here, keeping the temperature constant means reducing temperature changes to 3° C. or less.

In the present invention, the temperature of the medium during post exposure is made to be lower than the temperature of the medium during recording exposure. This makes it possible to reduce Haze in the non-recorded area of the optical element on which a hologram or the like is recorded.

The reasons for this are considered to be as follows.

Normally, post exposure is performed immediately after recording exposure under the same atmosphere, so the temperature of the medium during post exposure is the same as that during recording exposure.

However, by performing post exposure at a lower temperature of the medium, photopolymerization of unreacted polymerizable compounds occurs in an environment where the movement of the polymer in the matrix resin constituting the recording layer of the medium is slowed down. As a result, it becomes difficult for the polymers to aggregate with each other, and the size of the scatterer derived from the polymer becomes smaller. Therefore, low Haze can be achieved.

In the present invention, the difference between the temperature of the medium during recording exposure and the temperature of the medium during post exposure is preferably 5° C. or more, and more preferably 10° C. or more. By setting this temperature difference to 5° C. or more, the Haze in the non-recording area of the optical element tends to be significantly reduced. Further, the difference between the temperature during recording exposure and the temperature during post exposure is preferably 40° C. or less, more preferably 35° C. or less, and even more preferably 25° C. or less. By setting this temperature difference to 40° C. or less, it tends to be possible to prevent water-condensation on the medium due to temperature changes and to prevent an increase in Haze.

The temperature of the medium during the above post exposure is preferably 5° C. or higher. By setting the temperature of the medium at 5° C. or higher, light scattering due to water droplets generated by condensation on the medium during post exposure tends to be prevented. Further, it is possible to prevent an increase in Haze of the optical element by this light scattering. Further, the temperature of the medium during the above-described post exposure is preferably 35° C. or lower, more preferably 33° C. or lower, and even more preferably 30° C. or lower. By performing post exposure in this range, it is possible to prevent the diffusion of the polymer caused by photopolymerization during recording exposure, and to promote the polymerization of the photopolymer in the non-recorded area where the hologram is not recorded. Therefore, fixation can be performed while maintaining the density distribution during recording exposure. Therefore, it tends to be possible to achieve high diffraction efficiency.

Furthermore, it is preferable that the temperature of the medium during the above-described recording exposure is kept constant in order to prevent uneven interference fringes formed by recording exposure and maintain high diffraction efficiency by keeping the density and refractive index of the medium constant. Here, keeping the temperature constant means reducing temperature changes to 3° C. or less.

### [Light Intensity and Exposure Amount During Recording Exposure and Post Exposure]

In the present invention, light intensity means the energy per unit area of light irradiated onto a medium having a recording layer. The light intensity in the above recording exposure is the sum of the respective light intensity of the reference light and object light.

The light intensity during this recording exposure is preferably 2 mW/cm² or more, more preferably 5 mW/cm² or more, and even more preferably 10 mW/cm² or more. Within this range, rapid recording exposure is possible and the Haze of the recorded area is reduced. This tends to reduce noise generated during reproduction of recorded information.

On the other hand, the light intensity during this recording exposure is preferably 200 mW/cm² or less, more preferably 100 mW/cm² or less, and even more preferably 40 mW/cm² or less. Within this range, the polymerization reaction can be easily controlled by exposure time, and desired interference fringes tend to be stably recorded.

The exposure amount during recording exposure in the present invention can be arbitrarily selected depending on the type of photopolymerization initiator and the efficiency of the photopolymerization initiator. The exposure amount during recording exposure is preferably 0.5 J/cm² or more, and more preferably 1 J/cm² or more. Within this range, the photopolymerization initiator required during recording exposure reacts with light and becomes an active substance.

On the other hand, the exposure amount during recording exposure is preferably 100 J/cm² or less, more preferably 60 J/cm² or less, and even more preferably 24 J/cm² or less. Within this range, the time required for recording is shortened, and the producing takt can be shortened.

The exposure amount during post exposure in the present invention is 10 J/cm² or more, and preferably 20 J/cm² or more. By exposing the recording layer to light with an energy amount in this range, the photopolymerization initiator is sufficiently deactivated and the concentration distribution of the polymerized material in the optical element can be prevented from being broken by external light.

On the other hand, in order to shorten producing takt time by setting an appropriate exposure amount, the exposure amount during post exposure is preferably 5000 J/cm² or less, more preferably 1000 J/cm² or less, and even more preferably 500 J/cm² or less.

In the present invention, it is preferable that the light intensity during post exposure is 0.3 times or more higher than the light intensity during recording exposure.

By setting the light intensity during post exposure to 0.3 times or more higher than that during recording exposure, Haze in the non-recording area of the optical element can be reduced. It is more preferable that the light intensity during post exposure is 0.5 times or more higher than the light intensity during recording exposure. Since the reduction of Haze tends to be more pronounced, the light intensity during post exposure is set higher than that during recording exposure, and it is even more preferable that the light intensity during post exposure is set to a light intensity that is more than 1 times higher than the light intensity during recording exposure. This light intensity ratio is particularly preferably 1.2 times or more, especially preferably 2 times or more, and most preferably 4 times or more.

In addition, since the coloration caused by photodegradation of the matrix resin of the recording layer due to post exposure tends to be suppressed and the Haze of the non-recording area of the optical element is reduced, the light intensity during post exposure is preferably 100 times or less, more preferably 20 times or less, even more preferably 15 times or less, and particularly preferably 10 times or less lower than the light intensity during recording exposure.

Usually, post exposure is performed to fix the concentration distribution of the polymerized material formed by the recording exposure by accelerating the polymerization of the photopolymer in the non-recorded area, and to prevent the concentration distribution of the polymerized material created by the recording exposure from being destroyed by light exposure after this process. For this reason, the light intensity of post exposure is not particularly considered.

However, by increasing the light intensity during post exposure, more photopolymerization initiators are cleaved in a short time, and the number of polymerization initiation points in the matrix resin that constitutes the recording layer of the medium can be increased. Therefore, post exposure can be completed promptly. As a result, chain polymerization of the polymerizable compound in the non-recording area is suppressed, and the size of the polymer constituting the scatterer, which is the cause of the Haze in the non-recording area, can be reduced to achieve a low Haze.

Furthermore, the irradiation time to reach the light energy required to fix the concentration distribution described above can be shortened. Therefore, the takt time for manufacturing can also be shortened.

On the other hand, by setting the upper limit of light intensity during of post exposure appropriately, it is possible to prevent excessive temperature rise of the matrix resin that constitutes the recording layer of the medium. Thereby, the above-described chain polymerization can be made difficult to occur. Therefore, it tends to be possible to reduce the Haze in the non-recording area of the optical element.

### [Temperature Rise During Exposure]

In the present invention, even in cases when the matrix resin may excessively increase in temperature during post exposure, it is possible to prevent the above-described excessive temperature rise of the matrix resin by dissipating heat from the medium during post exposure.

This heat dissipation means is not particularly limited. As this heat dissipation means, for example, methods such as blowing air onto the medium using a blower fan, and removing heat from the medium by installing a heat dissipation fin or a temperature controller and the like can be adopted.

In the production of optical elements, when recording and exposing a medium having a recording layer containing a polymerizable compound and a photopolymerization initiator, it is usually carried out in an atmosphere around room temperature from the viewpoint of ease of management of production equipment. However, in the present invention, as described above, the temperature of the matrix resin in the recording layer of the medium may rise during post exposure. By preventing the temperature rise of this medium, it tends to be possible to prevent the coloring caused by photodeterioration of this matrix resin, and also to reduce the Haze in the non-recording area of the optical element, and to prevent the deterioration of recorded data (bleeding of interference fringes, etc.) that has been exposed to recording light.

Post exposure in the present invention can be carried out by single-sided exposure from either side of the medium, but it is preferable to expose from both sides of the medium. Thereby, post exposure can be completed in a short time, and a rise in temperature of the medium can also be prevented.

Methods of exposing from both sides of the medium include: placing a light source on each side of the medium for exposure; when the light source is placed on one side of the medium, placing a mirror or lens on the incident back side to reflect the light once transmitted through the medium, so that the light is exposed from both sides.

### [Exposure Light Source]

The light source that can be used for recording exposure in the present invention can be arbitrarily selected in the absorption wavelength region of the photopolymerization initiator. Particularly suitable light sources include, for example, lasers with excellent monochromaticity and directivity such as: solid lasers such as ruby, glass, Nd-YAG, Nd—YVO₄ lasers; diode lasers such as GaAs, InGaAs, and GaN lasers; gas lasers such as helium-neon, argon, krypton, excimer, and CO₂ lasers; and dye lasers including dyes.

The light source that can be used for post exposure in the present invention is not particularly limited as long as it can irradiate light in the absorption wavelength region of the photopolymerization initiator. The light source for post exposure can be arbitrarily selected from LEDs, UV lamps, xenon lamps, mercury lamps, and the like.

As for the light source used for post exposure in the present invention, it is preferable that at least one light source is incoherent light. By using incoherent light, it is possible to prevent the formation of unnecessary interference fringes in the non-recording area even when a plurality of light sources are employed, such as in the case of double-sided exposure described above. Examples of light sources for incoherent light include LEDs, UV lamps, xenon lamps, mercury lamps, and the like. As the light source of the incoherent light, any light source can be selected as long as it is capable of emitting light in the absorption wavelength region of the photopolymerization initiator.

The wavelength of the light for recording exposure in the present invention may be in the absorption wavelength region of the photopolymerization initiator, and can be arbitrarily selected from the ultraviolet region to the visible region. The wavelength of the light for recording exposure in the present invention is preferably 300 nm or more, more preferably 350 nm or more, and preferably 600 nm or less, and more preferably 450 nm or less. Within this range, the photopolymerization initiator required for recording exposure reacts with the light to become an active substance.

The wavelength of the light for post exposure in the present invention only needs to be in the absorption wavelength region of the photopolymerization initiator. The wavelength of the light for post exposure in the present invention is preferably 300 nm or more, more preferably 350 nm or more, and preferably 600 nm or less, and more preferably 450 nm or less. Within this range, effective inactivation treatment using a polymerization inhibitor is possible.

### [Total Light Transmittance of Optical Element]

The optical element obtained by the present invention preferably has a total light transmittance of 80% or more, more preferably 85% or more under a standard light source D65. Within the above range, for example, even when a holographically recorded optical element is used as an AR light guide plate, this optical element has sufficient light transmittance.

### [Components of Medium in the Present Invention]

The medium used in the present invention is useful as a holographic recording medium. The medium used in the present invention has a recording layer containing at least a polymerizable compound and a photopolymerization initiator. A preferable example of the composition for forming such a recording layer (hereinafter also referred to as a “recording layer forming composition”) includes a photopolymer containing in an appropriate matrix resin, a polymerizable monomer capable of radical polymerization or cationic polymerization as a polymerizable compound, a photopolymerization initiator that promotes the polymerization of the polymerizable monomer, and a polymerization inhibitor which is a substance that inhibits the polymerization of the polymerizable monomer.

### [Recording Layer]

### <About the Composition for Forming a Holographic Recording Layer>

The recording layer of the medium according to the present invention is formed from a recording layer forming composition described in detail below. Here, the matrix resin is usually made to exist in the recording layer as a crosslinked network structure by filling the recording layer forming composition between the flat substrates and then polymerizing or crosslinking the composition. Therefore, the matrix resin will be contained in the recording layer forming composition in the form of a composition for forming a matrix resin by polymerization or cross-linking.

That is, the recording layer forming composition according to the present invention can contain a polymerizable monomer, a composition for forming a matrix resin, a photopolymerization initiator, a polymerization inhibitor, and optionally a radical scavenger. The components of the composition for forming the hologram recording layer are described in detail below.

### <<About Polymerizable Monomers>>

The polymerizable monomer according to the present invention is a compound that can be polymerized using the photopolymerization initiator described later. No particular limitation is imposed on the type of polymerizable monomer, and an appropriate compound can be selected from known compounds. Examples of the polymerizable monomer include cationically polymerizable monomers, anionically polymerizable monomers, and radically polymerizable monomers. Any of these monomers can be used, and two or more of them may be used in combination.

Examples of the cationically polymerizable monomer include epoxy compounds, oxetane compounds, oxolane compounds, cyclic acetal compounds, cyclic lactone compounds, thiirane compounds, thietane compounds, vinyl ether compounds, spiro orthoester compounds, ethylenically unsaturated compounds, cyclic ether compounds, cyclic thioether compounds, and vinyl compounds. Any one of these cationically polymerizable monomers may be used alone, or any combination of two or more of them may be used at any ratio.

Examples of the anionically polymerizable monomer include hydrocarbon monomers and polar monomers.

Examples of the hydrocarbon monomers include styrene, α-methylstyrene, butadiene, isoprene, vinylpyridine, vinylanthracene, and derivatives thereof. Examples of the polar monomers including methacrylates, acrylates, vinyl ketones, isopropenyl ketones, and other polar monomers.

Any one of these anionically polymerizable monomers may be used alone, or any combination of two or more of them may be used at any ratio.

Examples of the radically polymerizable monomer include (meth) acryloyl group-containing compounds, (meth) acrylamides, vinyl esters, vinyl compounds, styrenes, and spiro ring-containing compounds. Any of these radically polymerizable monomers may be used alone, or any combination of two or more of them may be used at any ratio. Among the above compounds, (meth)acryloyl group-containing compounds are preferred in terms of steric hindrance during radical polymerization.

Among the above polymerizable monomers, compounds having a halogen atom (iodine, chlorine, bromine, etc.) or a hetero atom (nitrogen, sulfur, oxygen, etc.) in the molecule are preferred because they have a high refractive index. Among the above, those having a heterocyclic structure are preferable because they can obtain a higher refractive index.

### <<About Matrix Resin and Composition for Forming Matrix Resin>>

The matrix resin according to the present invention refers to a cured product having a crosslinked network structure formed by a polymerization reaction or a crosslinking reaction. The composition for forming a matrix resin refers to a matrix resin precursor before bond formation by polymerization reaction and crosslinking reaction.

The matrix resin has a crosslinked network structure. This allows the matrix resin to stabilize the spatially uniform dispersion of the polymerizable monomers and photopolymerization initiator in the recording layer by appropriately preventing the mobility of the polymerizable monomer and photopolymerization initiator. Further, the matrix resin prevents the diffusion of the polymer by intertwining with the polymer generated in the recording layer. The matrix resin prevents recorded information from being erased by preventing the diffusion of this polymer. Furthermore, since the matrix resin has a higher elastic modulus than in a liquid state, it plays a role of maintaining the physical shape of the recording layer.

The matrix resin forming composition is not restricted as long as it can maintain sufficient compatibility with the polymerizable monomer, its polymer, and photopolymerization initiator even after bond formation by polymerization reaction or crosslinking reaction. The matrix resin forming composition may preferably use a compound having at least two or more functional groups selected from the group consisting of an isocyanate group, a hydroxyl group, a mercapto group, an epoxy group, an amino group, and a carboxy group in the molecule alone or in combination.

The following examples (1) to (8) are examples of realizing a certain type of chemical bond that forms a crosslinked network structure by using one or more of these compounds in combination.
(1) Forming an isocyanurate bond through a reaction between compounds having isocyanate groups.
(2) Forming an urethane, a thiourethane, an urea, or an amide bonds by combining a compound having an isocyanate group and a compound having an active hydrogen in the molecule, such as compounds containing hydroxyl groups, mercapto groups, amino groups, or carboxy groups.
(3) Forming an ester bond by combining a compound having a hydroxyl group and a compound having a carboxy group.
(4) Forming an amide bond by combining a compound having an amino group and a compound having a carboxy group.
(5) Forming an ether bond through a reaction between compounds having epoxy groups.
(6) Forming an ether bond by combining an epoxy group and a hydroxyl group.
(7) Forming an amine bond by combining a compound having an epoxy group and a compound having an amino group.
(8) Forming multiple types of bonds including the above (1) to (7).

Among these, the combination of a compound having an isocyanate group and a compound having two or more hydroxyl groups in the molecule as an isocyanate-reactive functional group is preferable, because it provides a high degree of freedom in selecting the matrix resin structure and has no odor.

Examples of compounds having an isocyanate group include isocyanic acid, butyl isocyanate, octyl isocyanate, butyl diisocyanate, hexyl diisocyanate (HMDI), isophorone diisocyanate (IPDI), 1,8-diisocyanato-4-(isocyanatomethyl) octane, 2,2,4- and/or 2,4,4-trimethylhexamethylene diisocyanate, isomeric bis(4,4′-isocyanatocyclohexyl) methanes and mixtures thereof having any desired isomer content, isocyanatomethyl-1,8-octanediisocyanate, 1,4-cyclohexylene diisocyanate, isomeric cyclohexanedimethylene diisocyanates, 1,4-phenylene diisocyanate, 2,4- and/or 2,6-toluene diisocyanate, 1,5-naphthylene diisocyanate, 2,4′- and/or 4,4′-diphenylmethane diisocyanate and/or triphenylmethane 4,4′,4″-triisocyanate.

It is also possible to use an isocyanate derivative having a urethane structure, a urea structure, a carbodiimide structure, an acrylic urea structure, an isocyanurate structure, an allophanate structure, a biuret structure, an oxadiazinetrione structure, a uretdione structure, and/or an iminooxadiazinedione structure.

Any one of them may be used alone, or any combination of two or more of them may be used at any ratio.

Examples of compounds having two or more hydroxyl groups in the molecule as isocyanate-reactive functional groups include: glycols such as ethylene glycol, triethylene glycol, diethylene glycol, polyethylene glycol, propylene glycol, polypropylene glycol, and neopentyl glycol; diols such as butanediol, pentanediol, hexanediol, heptanediol, and tetramethylene glycol; bisphenols; compounds obtained by modifying these polyfunctional alcohols with a polyethyleneoxy chain or a polypropyleneoxy chain; triols such as glycerin, trimethylolpropane, butanetriol, pentanetriol, hexanetriol, and decanetriol, compounds obtained by modifying these polyfunctional alcohols with a polyethyleneoxy chain or a polypropyleneoxy chain; polyfunctional polyoxybutylenes; polyfunctional polycaprolactones; polyfunctional polyesters; polyfunctional polycarbonates; and polyfunctional polypropylene glycols.

Any one of them may be used alone, or any combination of two or more of them may be used at any ratio.

When forming a matrix resin, a combination of a compound having an epoxy group and a compound having an amino group includes a combination in which the reaction rate of bond formation in the matrix resin forming composition is relatively high. Therefore, in some cases, a matrix resin is formed as a bond-forming reaction progressing in a short time by leaving at room temperature.

On the other hand, a combination of a compound having an isocyanate group and a compound having a hydroxyl group, which has a high degree of freedom in selecting the matrix resin structure and is a preferable combination for forming a matrix resin, does not have a high reaction rate of bond formation, and the bond formation may not be completed and the matrix resin may not be formed even after standing at room temperature for several days. When using a composition for matrix resin formation with such a low reaction rate of bond formation, the bond formation reaction of the composition for matrix resin formation can be accelerated by heating, as in a general chemical reaction. Therefore, depending on the composition for forming the matrix resin, it is preferable to heat the composition for forming the recording layer between the two substrates for the formation of the matrix resin after filling the composition for forming the recording layer between the two substrates.

Furthermore, the bond formation reaction of the composition for forming the matrix resin can also be promoted by using a suitable catalyst. Examples of such catalysts include onium salts such as bis(4-t-butylphenyl) iodonium perfluoro-1-butanesulfonic acid, bis(4-t -butylphenyl) iodonium p-toluenesulfonic acid, and the like; Lewis acid-based catalysts such as zinc chloride, tin chloride, iron chloride, aluminum chloride, BF₃ and the like; protic acids such as hydrochloric acid, phosphoric acid and the like; amines such as trimethylamine, triethylamine, triethylenediamine, dimethylbenzylamine, diazabicycloundecene, and the like; imidazoles such as 2-methylimidazole, 2-ethyl-4-methylimidazole, 1-cyanoethyl-2-undecylimidazolium trimellitate, and the like; bases such as sodium hydroxide, potassium hydroxide, potassium carbonate, and the like; tin catalysts such as dibutyltin laurate, dioctyltin laurate, dibutyltin octoate, and the like; bismuth catalysts such as tris(2-ethylhexanoate)bismuth, tribenzoyloxybismuth, bismuth triacetate, tris(dimethyldiocarbamic acid) bismuth, bismuth hydroxide, and the like.

Any one type of catalyst may be used alone, or two or more types may be used in combination in any combination and ratio.

### <<About Photoinitiators>>

The photopolymerization initiator according to the present invention refers to one that generates cations, anions, or radicals when irradiated with light. The photopolymerization initiator contributes to the polymerization of the above-described polymerizable monomer. The type of photopolymerization initiator is not particularly limited, and can be appropriately selected depending on the type of polymerizable monomer.

The cationic photopolymerization initiator used may be any known cationic photopolymerization initiator. Examples of the cationic photopolymerization initiator include aromatic onium salts. Specific examples of the aromatic onium salts include compounds containing an anionic component such as SbF₆⁻, BF₄⁻, AsF₆⁻, PF₆, CF₃SO₃⁻, or B (C₆F₅)₄⁻ and an aromatic cationic component containing an atom such as iodine, sulfur, nitrogen, or phosphorus. Of these, diaryliodonium salts, triarylsulfonium salts, etc. are preferred.

Any one of the above exemplified cationic photopolymerization initiators may be used alone, or any combination of two or more of them may be used at any ratio.

The anionic photopolymerization initiator used may be any known anionic photopolymerization initiator. Examples of the anionic photopolymerization initiator include amines. Examples of the amines include: amino group-containing compounds such as dimethylbenzylamine, dimethylaminomethylphenol, 1,8-diazabicyclo[5.4.0] undecene-7, and derivatives thereof; and imidazole compounds such as imidazole, 2-methylimidazole, 2-ethyl-4-methylimidazole, and derivatives thereof.

Any one of the above-exemplified anionic photopolymerization initiators may be used alone, or any combination of two or more of them may be used at any ratio.

The radical photopolymerization initiator used may be any known radical photopolymerization initiator. Examples of the radical photopolymerization initiator used include phosphine oxide compounds, azo compounds, azide compounds, organic peroxides, organic boronic acid salts, onium salts, bisimidazole derivatives, titanocene compounds, iodonium salts, organic thiol compounds, halogenated hydrocarbon derivatives and oxime ester compounds.

Any one of the above-exemplified radical photopolymerization initiators may be used alone, or any combination of two or more of them may be used at any ratio.

Other examples of photopolymerization initiators include imidazole derivatives, oxadiazole derivatives, naphthalene, perylene, pyrene, anthracene, coumarin, chrysene, p-bis(2-phenylethenyl)benzene and their derivatives, quinacridone derivatives, coumarin derivatives, aluminum complexes such as Al(C₉H₆(NO)₃, rubrene, perimidone derivatives, benzopyran derivatives, rhodamine derivatives, benzothioxanthene derivatives, azabenzothioxanthene, phenylpyridine complexes, porphyrin complexes, polyphenylene vinylene materials, and the like.

### <<About Polymerization Inhibitors>>

The polymerization inhibitor according to the present invention refers to a substance that inhibits the polymerization reaction of the polymerizable monomer, and can be used as necessary. The polymerization inhibitor has the effect of inhibiting the progress of unexpected polymerization reactions such as those described below, and improving the storage stability of the medium before holographic recording. For example, the unexpected polymerization reaction is that in the recording layer before holographic recording, a polymerization reaction of the polymerizable monomer is initiated by radicals generated by the polymerization initiator and the polymerizable monomer due to a slight amount of light or heat in the storage environment.

The type of polymerization inhibitor is not particularly limited as long as it can inhibit the polymerization reaction of the polymerizable monomer. Specific examples of the polymerization inhibitor include phosphinates such as sodium phosphate sodium hypophosphite, and the like; mercaptans such as mercaptoacetic acid, mercaptopropionic acid, 2-propanethiol, 2-mercaptoethanol, thiophenol, and the like; aldehydes such as acetaldehyde, propionaldehyde, and the like; ketones such as acetone, methyl ethyl ketone, and the like; halogenated hydrocarbons such as trichlorethylene, perchlorethylene, and the like; terpenes such as terpinolene, α-terpinene, β-terpinene, γ-terpinene, and the like; non-conjugated dienes such as 1,4-cyclohexadiene, 1,4-cycloheptadiene, 1,4-cyclooctadiene, 1,4-heptadiene, 1,4-hexadiene, 2-methyl-1,4-pentadiene, 3,6-nonanedien-1-ol, 9,12-octadecadienol, and the like; linolenic acids such as linolenic acid, β-linolenic acid, methyl linolenate, ethyl linolenate, isopropyl linolenate, linolenic anhydride, and the like; linoleic acids such as linoleic acid, methyl linoleate, ethyl linoleate, isopropyl linoleate, linoleic anhydride, and the like; eicosapentaenoic acids such as eicosapentaenoic acid ethyl eicosapentaenoate, and the like; docosahexaenoic acids such as docosahexaenoic acid, ethyl docosahexaenoate, and the like; phenol derivatives such as 2,6-di-t-butyl-p-cresol, p-methoxyphenol, diphenyl-p-benzoquinone, benzoquinone, hydroquinone, pyrogallol, resorcinol, phenanthraquinone, 2,5-torquinone, benzylaminophenol, p-dihydroxybenzene, 2,4,6-trimethylphenol, butylated hydroxytoluene, and the like; nitrobenzene derivatives such as o-dinitrobenzene, p-dinitrobenzene, m-dinitrobenzene, and the like; N-phenyl-1-naphthylamine, N-phenyl-2-naphthylamine, cuperone, phenothiazine, tannic acid, p-nitrosamine, chloranil, aniline, hindered aniline, iron (III) chloride, copper (II) chloride, triethylamine, hindered amine, nitroxy radicals including 2,2,6,6-tetramethylpiperidine-1-oxyl, triphenylmethyl radical, oxygen, and the like.

For these components, conventionally known materials may be used alone, or two or more may be used in combination in any combination and ratio.

### <<About Radical Scavengers>>

In holographic recording, a radical scavenger may be added in order to accurately fix the interference light intensity pattern as a polymer r distribution in the holographic recording medium. The radical scavenger preferably has both a functional group that captures radicals and a reactive group that is covalently fixed to the matrix resin. A stable nitroxyl radical group can be mentioned as a functional group that captures radicals.

Examples of the reactive groups fixed to the matrix resin by covalent bonds include hydroxyl groups, amino groups, isocyanate groups, and thiol groups. As these radical scavengers, 4-hydroxy-2,2,6,6-tetramethylpiperidine-1-oxyl free radical (TEMPOL), 3-hydroxy-9-azabicyclo[3.3.1] nonane N-oxyl, 3-hydroxy-8-azabicyclo[3.2.1]octane N-oxyl, and 5-HO-AZADO: 5-hydroxy-2-azabicyclo[3.3. 1.1^{3,7}] decane N-oxyl can be mentioned.

The various radical scavengers described above may be used alone or in combination of two or more in any combination and ratio.

### <<About Other Additives>>

Other components contained in the recording layer forming composition include a solvent, a plasticizer, a dispersant, a leveling agent, an antifoaming agent, an adhesion promoter, a compatibilizer, a sensitizer, and the like. For these components, conventionally known materials may be used alone, or two or more of them may be used in any combination and ratio.

### <<About the Content of Each Material>>

The content of each component in the recording layer forming composition according to the present embodiment is arbitrary as long as it does not depart from the spirit of the present invention. The proportion of each component in the recording layer forming composition according to the present embodiment is preferably within the following range based on the total mass of the composition.

The content of the total amount of matrix resin is usually 0.1% by mass or more, preferably 10% by mass or more, and more preferably 35% by mass or more. Further, it is usually 99.9% by mass or less, preferably 99% by mass or less, and more preferably 98% by mass or less. By setting the content of the matrix resin to the above lower limit or more, it becomes easy to form the recording layer.

The content of the catalyst used to promote matrix resin formation is preferably determined in consideration of the rate of bond formation of the matrix-forming components. The content of the catalyst is usually 5% by mass or less, preferably 4% by mass or less, and more preferably 1% by mass or less. Further, it is usually preferable to use 0.005% by mass or more.

The content of the polymerizable monomer is usually 0.1% by mass or more, preferably 1% by mass or more, and more preferably 2% by mass or more. Further, it is usually 80% by mass or less, preferably 50% by mass or less, and more preferably 30% by mass or less. Sufficient diffraction efficiency can be obtained when the content of polymerizable monomer is at least the above lower limit. The compatibility of the recording layer is maintained when the content of the polymerizable monomer is equal to or less than the above upper limit.

The content of the photopolymerization initiator is usually 0.1% by mass or more, preferably 0.3% by mass or more, and usually 20% by mass or less, preferably 18% by mass or less, more preferably 16% by mass or less. Sufficient recording sensitivity can be obtained when the content of the photopolymerization initiator is at least the above lower limit. Coloration immediately after recording is suppressed when the content of the photopolymerization initiator is equal to or less than the above upper limit.

The content of the polymerization inhibitor is usually 0.001% by mass or more, and preferably 0.005% by mass or more. Further, it is usually 30% by mass or less, and preferably 10% by mass or less. When the content of the polymerization inhibitor is within the above range, it is possible to inhibit the progress of unexpected polymerization reactions initiated by radicals generated by slight light or heat.

The content of the radical scavenger is preferably 0.5 μmol/g or more, more preferably 1 μmol/g or more and 100 μmol/g or less, more preferably 50 μmol/g in molar amount per unit weight of the matrix forming component.

When the content of the radical scavenger is equal to or higher than the above lower limit, the radical scavenging efficiency will be excellent, the polymer with a low degree of polymerization will not diffuse, and the components that do not contribute to the signal will tend to decrease. On the other hand, when the content of the radical scavenger is equal to or less than the above upper limit, the polymerization efficiency of the polymer will be excellent.

The total content of other components is usually 30% by mass or less, preferably 15% by mass or less, and more preferably 5% by mass or less.

### <About the Thickness of the Recording Layer>

The thickness of the recording layer in the present invention is preferably 0.1 mm or more and 3.0 mm or less, more preferably 0.3 mm or more and 2 mm or less. Within this range, the selectivity of each hologram becomes high during multiplex recording on the holographic recording medium, and the degree of multiplex recording tends to be high. Furthermore, the light transmittance of the recording layer at the recording light wavelength can be maintained high, and it becomes possible to record uniformly over the entire recording layer in the thickness direction, which tends to make it possible to realize multiple recording with a high S/N ratio.

### [Other Layers]

The medium in the present invention includes a recording layer and, if necessary, a support and other layers. Usually, a medium has a support, and a recording layer and other layers are laminated on this support to constitute the medium. However, if the recording layer or other layers have the strength and durability required for the medium, the medium may not have a support. Examples of other layers include a protective layer, a reflective layer, an anti-reflection layer (anti-reflection film), and the like.

### <Support>

No particular limitation is imposed on the details of the support so long as it has the strength and durability required for the medium, and any support can be used.

No limitation is imposed on the shape of the support, and the support is generally formed into a flat plate or a film.

No limitation is imposed on the material forming the support, and the material may be transparent or may be opaque.

Examples of the material for the transparent support include organic materials such as acrylic, polyethylene terephthalate, polyethylene naphthoate, polycarbonate, polyethylene, polypropylene, amorphous polyolefin, polystyrene, and cellulose acetate; and inorganic materials such as glass, silicon, and quartz. Of these, polycarbonate, acrylic, polyester, amorphous polyolefin, glass, etc. are preferred, and polycarbonate, acrylic, amorphous polyolefin, and glass are more preferred.

Examples of the material for the opaque support include metals such as aluminum; and a coating material obtained by coating the above-mentioned transparent support with a metal such as gold, silver, or aluminum, or a dielectric such as magnesium fluoride or zirconium oxide.

No particular limitation is imposed on the thickness of the support. Preferably, the thickness is in the range of generally 0.05 mm or more and 1 mm or less. When the thickness of the support is equal to or more than the above lower limit, the mechanical strength of the holographic recording medium can be ensured, and warpage of the substrate can be prevented. When the thickness of the support is equal to or less than the above upper limit, the transmission amount of light can be ensured, and an increase in cost can be prevented.

The surface of the support may be subjected to surface treatment. The surface treatment is generally performed in order to improve the adhesion between the support and the recording layer. Examples of the surface treatment include corona discharge treatment performed on the support and the formation of an undercoat layer on the support in advance. Examples of the composition for the undercoat layer include halogenated phenols, partially hydrolyzed vinyl chloride-vinyl acetate copolymers, and polyurethane resins.

The surface treatment on the support may be performed for a purpose other than the improvement in adhesion. Examples of such surface treatment include reflecting coating treatment in which a reflecting coating layer is formed using a metal material such as gold, silver, or aluminum; and dielectric coating treatment in which a dielectric layer formed of magnesium fluoride, zirconium oxide, etc. Such a layer may be formed as a single layer, or two or more layers may be formed.

The surface treatment on the support may be performed for the purpose of controlling the gas and water permeability of the substrate. For example, when the support supporting the recording layer has the function of preventing permeation of gas and water, the reliability of the medium can be further improved.

The support may be disposed only on one of the upper and lower sides of the recording layer of the holographic recording medium of the present invention or may be disposed on both sides. When supports are disposed on both the upper and lower sides of the recording layer, at least one of the supports is made transparent so that it can transmit active energy rays (such as excitation light, reference light, and reproduction light).

When the holographic recording medium has the support on one side or both sides of the recording layer, a transmission hologram or a reflection hologram can be recorded. When a support having reflection characteristics is used on one side of the recording layer, a reflection hologram can be recorded.

A pattern for data addressing may be provided on the support. In this case, no limitation is imposed on the patterning method. For example, irregularities may be formed on the support itself, or the pattern may be formed on the reflecting layer described later. The pattern may be formed using a combination of these methods.

### <Protective Layer>

The protective layer is a layer for preventing a reduction in the sensitivity of the recording layer and deterioration in its storage stability due to oxygen or moisture. No limitation is imposed on the specific structure of the protective layer, and any known protective layer can be used. For example, a layer formed of a water-soluble polymer, an organic or inorganic material, etc. can be formed as the protective layer.

No particular limitation is imposed on the formation position of the protective layer. The protective layer may be formed, for example, on the surface of the recording layer or between the recording layer and the support or may be formed on the outer surface side of the support. The protective layer may be formed between the support and another layer.

### <Reflecting Layer>

The reflecting layer is formed when the holographic recording medium formed is of the reflection type. In the reflection holographic recording medium, the reflecting layer may be formed between the support and the recording layer or may be formed on the outer side of the support. Generally, it is preferable that the reflecting layer is present between the support and the recording layer.

Any known reflecting layer may be used, and a thin metal film, for example, may be used.

### <Anti-Reflection Film>

When configuring the medium of the present invention as either a transmission type or a reflection type holographic recording medium, an anti-reflection film may be disposed on the side on/from which object light and reading light are incident/emitted or between the recording layer and the support. The anti-reflection film improves the efficiency of utilization of light and prevents the occurrence of a ghost image.

Any known anti-reflection film may be used.

### EXAMPLES

The present invention will be described in more detail by way of Examples. The present invention is not limited to the Examples so long as the invention does not depart from the scope thereof.

### [Materials Used]

Raw materials of compositions used in the Examples, and Comparative Examples are as follows.

### (Isocyanate Group-Containing Compound)

DURANATE™ TSS-100: hexamethylene diisocyanate-based polyisocyanate (NCO 17.6%) (manufactured by Asahi Kasei Corporation) (Isocyanate-reactive functional group-containing compound)
PLACCEL PCL-205U: polycaprolactonediol (molecular weight 530, manufactured by Daicel Corporation)
PLACCEL PCL-305: polycaprolactonetriol (molecular weight 550, manufactured by Daicel Corporation) (Polymerizable monomer)
HLM101: 2,2-bis(4-dibenzothiophenylthiomethyl)-3-(4-dibenzothiophenylthio) propyl acrylate
HLM201: 2-[[2,2-bis(4-dibenzothiophenylthiomethyl)-3-(4-dibenzothiophenylthio) propoxy] carbonylamino]ethyl acrylate (Photopolymerization initiator)
HLI02: 1-(9-ethyl-6-cyclohexanoyl-9H-carbazol-3-yl)-1-(0-acetyloxime)methyl glutarate

### (Curing Catalyst)

Octylic acid solution of tris(2-ethylhexanoate)bismuth (active ingredient amount 56% by mass)

### (Radical Scavenger)

4-hydroxy-2,2,6,6-tetramethylpiperidine-1-oxyl free radical (TEMPOL, manufactured by TOKYO CHEMICAL INDUSTRY CO., Ltd.)

### [Preparation of TEMPOL Masterbatch]

0.03 g of TEMPOL was dissolved in 2.97 g of DURANATE™TSS-100. Next, 0.0003 g of an octylic acid solution of tris(2-ethylhexanoate)bismuth was dissolved in the above mixture, and the resulting mixture was stirred at 45° C. under reduced pressure to allow the mixture to react for 2 hours.

### [Preparation of Recording Layer Forming Composition and Producing of Holographic Recording Medium]

### <Holographic Recording Medium 1>

0.7599 g of polymerizable monomer HLM101, 0.0304 g of photopolymerization initiator HLI02, and 1.0411 g of TEMPOL masterbatch were dissolved 2.8794 g of DURANATE TMTSS-100 to obtain solution A.

Separately, 1.795 g of PLAXEL PCL-205U and 1.795 g of PLAXEL PCL-305 were mixed (PLAXEL PCL-205U: PLAXEL PCL-305=50:50 (weight ratio)), and 0.00023 g of an octylic acid solution of tris(2-ethylhexanoate)bismuth was dissolved therein to obtain solution B.

After degassing solution A for 2 hours under reduced pressure and degassing solution B for 2 hours under reduced pressure at 45° C., 2.5537 g of solution A and 1.9463 g of solution B were mixed with stirring. Then the above mixed solution was poured onto a slide glass with 0.5 mm-thick spacer sheets placed on two opposite edges, and another slide glass was placed thereon. Clips were used to fix the edges, and heating was performed at 80° C. for 24 hours to produce a holographic recording medium composition evaluation sample. In this evaluation sample, a recording layer with a thickness of 0.5 mm was formed between the slide glasses used as covers.

### <Holographic Recording Medium 2>

2.0811 g of polymerizable monomer HLM102, 0.0749 g of photopolymerization initiator HLI02, and 2.8095 g of TEMPOL masterbatch were dissolved 5.8207 g of DURANATE TMTSS-100 to obtain solution A.

Separately, 3.949 g of PLAXEL PCL-205U and 3.949 g of PLAXEL PCL-305 were mixed (PLAXEL PCL-205U: PLAXEL PCL-305=50:50 (weight ratio)), and 0.00025 g of an octylic acid solution of tris(2-ethylhexanoate)bismuth was dissolved therein to obtain solution B.

After degassing solution A for 2 hours under reduced pressure and degassing solution B for 2 hours under reduced pressure at 45° C., 5.1955 g of solution A and 3.8045 g of solution B were mixed with stirring.

Then the above mixed solution was poured onto a slide glass with 0.5 mm-thick spacer sheets placed on two opposite edges, and another slide glass was placed thereon. Clips were used to fix the edges, and heating was performed at 80° ° C. for 24 hours to produce a holographic recording medium composition evaluation sample. In this evaluation sample, a recording layer with a thickness of 0.5 mm was formed between the slide glasses used as covers.

### [Producing of Optical Elements]

### <Holographic Recording Device>

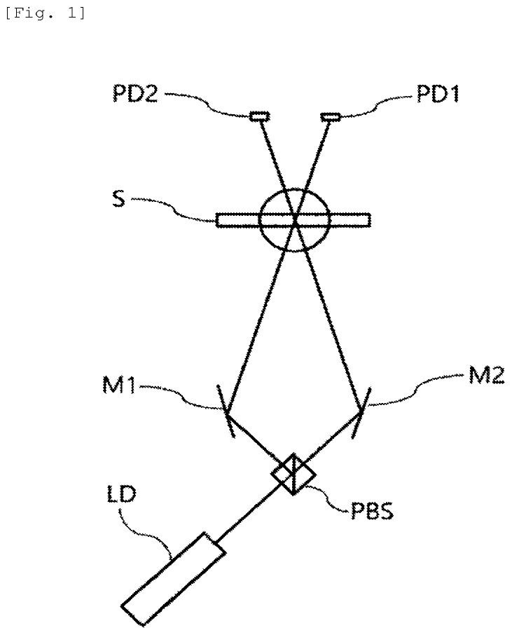

FIG. 1 is a structural diagram showing the outline of the device used for holographic recording on the medium.

In FIG. 1, S represents a holographic recording medium sample, and M1 and M2 represent mirrors. PBS represents a polarizing beam splitter. LD represents a recording laser light source emitting light with a wavelength of 405 nm (a single mode laser manufactured by TOPTICA Photonics and capable of emitting light with a wavelength of about 405 nm). PD1 and PD2 represent photodetectors.

### <Holographic Recording Exposure>

The light beam having a wavelength of 405 nm generated from the LD was split using the PBS, and these are considered as reference light and object light. And the two beams were intersected into two beams intersecting on a recording surface such that the angle therebetween was as follows. In this case, the light beam was split such that a bisector (hereinafter referred to as the optical axis) of the angle between the two beams was perpendicular to the recording surface of the holographic recording medium, and the two beams obtained by splitting the light beam were applied such that the vibration planes of the electric field vectors of the two beams were perpendicular to a plane including the two intersecting beams. The above case was assumed to be 0°, and while the incident direction of the two beams is fixed, the direction of the holographic recording medium was changed to change the angle of the recording surface with respect to the optical axis from −23.5° to 23.5°, 151 multiplexed holograms were recorded while changing the angle in 0.3° increments. At this time, the light intensity per beam was 10.2 mW/cm², and the exposure energy density of the recording light per one multiplex recording was 20.4 mJ/cm². Further, the recording exposure temperature was 25° C. At this time, the temperature of the recording medium was also 25° C.

### (Angle Between Two Beams)

### Examples 1 to 8 and Comparative Examples 1 to 6: 37.3° Reference Examples 1 to 10 and Comparative Reference Example 1: 59.3°

### [Examples and Comparative Examples Showing the Effect of the Difference Between the Temperature During Recording Exposure and the Temperature During Post Exposure]

### <Post Exposure>

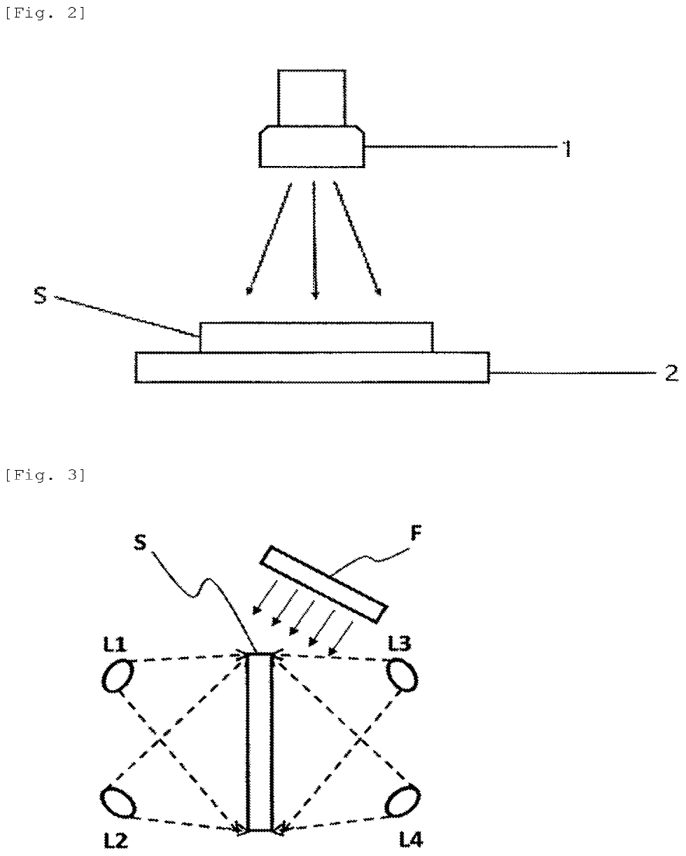

FIG. 2 is a schematic diagram showing an outline of the apparatus used for post exposure. The temperature of the medium on which the hologram was recorded and exposed was adjusted using the temperature control plate 2, and light was irradiated using the LED 1 so that the amount of post exposure was 25 J/cm², thereby producing an optical element.

In Examples 1 to 8, holographic recording medium 1 or 2 was used, and post exposure was performed after adjusting the temperature of the medium so that the difference between the temperature during recording exposure and the temperature during post exposure (recording exposure temperature-post exposure temperature) was 5° C. to 20° C.

In Comparative Examples 1 to 6, holographic recording medium 1 or 2 was used, and post exposure was performed after adjusting the temperature of the temperature of the medium so that the difference between the temperature during recording exposure and the temperature during post exposure was 0° C. to −15° C.

### <Evaluation of Haze in Non-Recorded Areas>

The Haze of the non-recorded areas of the obtained optical element was evaluated using NDH700SPII (manufactured by Nippon Denshoku Industries Co., Ltd.) (reference: air). Measurement was performed three times using the above device, and the average value was taken as the value of Haze.

The method for calculating Haze by the device is as follows.

$$Haze [ \% ] = ( diffuse light component / total light transmittance ) \times 100$$

### <Evaluation Results>

Table 1 shows the Haze (8) of the non-recorded areas of Examples 1 to 8 and Comparative Examples 1 to 6.

In Table 1, “holographic recording medium” is written as “medium”.

### [Table 1]

TABLE 1

| | | Recording exposure | | |
|---|---|---|---|---|
| | | temperature − Post | | |
| | Medium | exposure temperature | | Haze |
| | type | (° C.)※ | | (%) |
| Example1 | Medium1 | 20 | (5° C.) | 0.027 |
| Example2 | Medium1 | 15 | (10° C.) | 0.020 |
| Example3 | Medium1 | 10 | (15° C.) | 0.043 |
| Example4 | Medium1 | 10 | (15° C.) | 0.040 |
| Example5 | Medium1 | 5 | (20° C.) | 0.066 |
| Example6 | Medium2 | 15 | (10° C.) | 0.033 |
| Example7 | Medium2 | 10 | (15° C.) | 0.040 |
| Example8 | Medium2 | 5 | (20° C.) | 0.062 |
| Comparative Example1 | Medium1 | 0 | (25° C.) | 0.090 |
| Comparative Example2 | Medium1 | −5 | (30° C.) | 0.112 |
| Comparative Example3 | Medium1 | −10 | (35° C.) | 0.110 |
| Comparative Example4 | Medium1 | −15 | (40° C.) | 0.120 |
| Comparative Example5 | Medium2 | 0 | (25° C.) | 0.087 |
| Comparative Example6 | Medium2 | −5 | (30° C.) | 0.107 |

※The temperature in parentheses is the temperature duaring post exposure.

From Examples 1 to 8 and Comparative Examples 1 to 6, it can be seen that when the recording exposure temperature-post exposure temperature is a positive value, that is, when the temperature during post exposure is lower than the temperature during recording exposure, in both cases of holographic recording medium 1 and 2, the Haze of the non-recorded area of the obtained optical element is significantly lower than that in the case where the recording exposure temperature-post exposure temperature is 0° C. or less.

### [Reference Examples and Reference Comparative Example Showing the Effect of the Ratio of Light Intensity During Recording Exposure to Light Intensity During Post Exposure]

### <Post Exposure>

FIG. 3 is a schematic diagram showing an outline of the apparatus used for post exposure. L1, L2, L3, and L4 all indicate 405 nm LEDs manufactured by Thorlabs, Com. and F is a blower fan. An optical element was produced by adjusting the LED so that the light intensity became an arbitrary value, changing the exposure time, and performing light irradiation so that the post exposure amount was 38 J/cm².

In Reference Examples 1 to 10, post exposure was performed using the holographic recording medium 1 with the light intensity adjusted to 10 to 320 mW/cm² (light intensity ratio 0.49 to 15.70). In the case of a light intensity of 100 to 320 mW/cm², post exposure was performed while radiating heat from the sample surface using a blower fan F.

In Comparative Reference Example 1, holographic recording medium 1 was used and post exposure was performed with the light intensity adjusted to 5 mW/cm².

In Table 2 below, the ratio of the light intensity during post exposure to the light intensity during recording exposure is described as “light intensity ratio (post exposure/recording exposure)”.

### <Evaluation of Haze in Non-Recorded Areas>

The Haze of the non-recorded areas of the obtained optical element was evaluated using NDH700SPII (manufactured by Nippon Denshoku Industries Co., Ltd.) (reference: air). Measurement was performed three times using the above device, and the average value was taken as the value of Haze.

The method for calculating Haze by the device is as follows.

$$Haze [ \% ] = ( diffuse light component / total light transmittance ) \times 100$$

### <Evaluation Results>

Table 2 shows the Haze (%) of the non-recorded areas of Reference Examples 1 to 10 and Comparative Reference Example 1.

TABLE 2

| | Light intensity ratio | Presence or | Recording exposure temperature − | | |
|---|---|---|---|---|---|
| | (post exposure/ | Absence of heat | Post exposure temperature | | Haze |
| | recording exposure) | dissipation fan | (° C.)※ | | (%) |
| Reference Example1 | 0.49 | Absence | −0.5 | (25.5° C.) | 0.113 |
| Reference Example2 | 0.98 | Absence | −1 | (26° C.) | 0.100 |
| Reference Example3 | 2.00 | Absence | −1.5 | (26.5° C.) | 0.097 |
| Reference Example4 | 3.90 | Absence | −2.5 | (27.5° C.) | 0.093 |
| Reference Example5 | 4.90 | Absence | −3.5 | (28.5° C.) | 0.090 |
| Reference Example6 | 8.80 | Absence | −5 | (30° C.) | 0.090 |
| Reference Example7 | 15.70 | Absence | −11 | (36° C.) | 0.087 |
| Reference Example8 | 4.90 | Presence | −1 | (26° C.) | 0.080 |
| Reference Example9 | 7.40 | Presence | −2.5 | (27.5° C.) | 0.073 |
| Reference Example10 | 15.70 | Presence | −5.5 | (30.5° C.) | 0.077 |
| Comparative Reference Example1 | 0.25 | Absence | 0 | (25.0° C.) | 0.120 |

※The temperature in parentheses is the temperature duaring post exposure.

From Reference Examples 1 to 10 and Comparative Reference Example 1, it can be seen that by setting the ratio of the light intensity of post exposure to the light intensity of recording exposure to 0.3 or more, the Haze of the non-recording area of the obtained optical element is reduced. And it can also be seen that Haze is further significantly reduced by suppressing the temperature rise by the heat dissipation fan and suppressing the temperature rise during post exposure relative to the temperature during recording exposure.

Although the present invention has been described in detail by way of the specific modes, it is apparent for those skilled in the art that various changes can be made without departing from the spirit and scope of the present invention.

The present application is based on Japanese Patent Application No. 2021-176018 filed on Oct. 28, 2021, and Japanese Patent Application No. 2021-215449 filed on Dec. 29, 2021, the entire contents of which are incorporated herein by reference.

### INDUSTRIAL APPLICABILITY

The method for producing an optical element of the present invention is useful as a means of reducing the Haze of non-recorded area in optical elements with recorded holograms, especially for use in AR glass light guide plates and the like.

### REFERENCE SIGNS LIST

FIG. 1
S holographic recording medium
M1, M2 mirror
LD semiconductor laser light source for recording light
PD1, PD2 photodetector
PBS polarizing beam splitter

FIG. 2
S medium on which holograms are recorded and xposed
1 LED unit
2 temperature control plate

FIG. 3
S medium on which holograms are recorded and exposed
L1, L2, L3, L4 LED unit
F blower fan

1. A method for producing an optical element, comprising:
performing recording exposure on a medium having a recording layer containing a polymerizable compound and a photopolymerization initiator; and
performing post exposure on the medium in a state where a temperature of the medium is lower than during the recording exposure.

2. The method for producing an optical element according to claim 1, wherein a difference between the temperature of the medium during the recording exposure and the temperature of the medium during the post exposure is 5° C. or higher.

3. The method for producing an optical element according to claim 1, wherein the temperature of the medium during the post exposure is 5° C. or higher.

4. The method for producing an optical element according to claim 1, wherein the temperature of the medium during the recording exposure is 10° C. or higher and 40° C. or lower.

5. The method for producing an optical element according to claim 1, wherein the post exposure is performed at a light intensity 0.3 times or more higher than that of the recording exposure.

6. The method for producing an optical element according to claim 1, wherein a light source for post exposure during the post exposure is incoherent light.

7. The method for producing an optical element according to claim 1, wherein the medium comprises an upper side and a lower side, and
wherein the post exposure is performed from both sides of the medium.

8. The method for producing an optical element according to claim 1, wherein the recording exposure is a holographic recording exposure.
